(19) United States
(12) Patent Application Publication
(10) Pub. No.: US 2016/0359341 A1
(43) Pub. Date: Dec. 8, 2016

(54) WEARABLE POWER SUPPLY AND ASSOCIATED POWER SUPPLY METHOD

(71) Applicant: JRD COMUNICATION INC., Shenzhen, Guangdong (CN)

(72) Inventors: Yanfeng Huang, Shenzhen, Guangdong (CN); Libin Zhou, Shenzhen, Guangdong (CN); Zhihua Li, Shenzhen, Guangdong (CN); Peng Ding, Shenzhen, Guangdong (CN); Zhihua Tao, Shenzhen, Guangdong (CN)

(73) Assignee: JRD COMUNICATION INC., Shenzhen, Guangdong (CN)

(21) Appl. No.: 15/104,221

(22) PCT Filed: Jul. 6, 2015
(86) PCT No.: PCT/CN2015/083365

§ 371 Date: Jun. 13, 2016

(30) Foreign Application Priority Data
Jan. 28, 2015 (CN) 201510044159.8

(51) Int. Cl. H02J 7/00; G04G 19/00

(52) U.S. Cl. CPC H02J 7/007; H02J 7/0047; G04G 19/00; H02J 2007/0096

(57) ABSTRACT

A wearable power supply includes a control module, a battery; and a first charge module, a second charge module, a communication module, and a remaining capacity computation module, which are connected to the control module. The first charge module includes a driver and a first interface used to charge the battery. The driver is connected to the control module, the first interface, and the battery, respectively. The second charge module includes a voltage boost driver and a second interface used to charge a terminal. The voltage boost driver is connected to the control module, the battery, and the second interface, respectively. The voltage boost driver steps up an output voltage of the battery. The remaining capacity computation module adjusts the remaining capacity value of the battery in real time based on the battery discharging curve. The communication module sends the adjusted remaining battery capacity value to the terminal to display.

### FIELD OF THE DISCLOSURE

The present disclosure relates to power supplies, and more particularly, to a wearable power supply and an associated power supply method.

### BACKGROUND OF THE DISCLOSURE

As the continuous enrichment of functionalities of mobile devices, the usage of mobile devices is gradually increasing, and the power consumption is inevitably rising. For example, a smart watch with a 200 mA to 400 mA built-in battery cannot meet the common daily use. If, however, equipped with a battery of larger capacity, the smart watch may result in an increased size and may also add to its cost, which is not conducive to the marketing.

Typically, mobile devices, such as a smart watch, can be charged by a mobile power supply, but the existing mobile power supplies are generally of a large size, and cannot display the remaining capacity of the mobile power supply, which adds to the complexity of usage.

### SUMMARY OF THE DISCLOSURE

A principal problem to be addressed by the disclosure is to provide a wearable power supply and an associated power supply method. The wearable power supply features portability and convenience that it can display its remaining capacity on a display of a charged device in real time.

To achieve the above objectives, one technical solution adopted by the disclosure is to provide a wearable power supply, which includes a control module, a battery; and a first charge module, a second charge module, a communication module, and a remaining capacity computation module, which are connected to the control module.

The first charge module may include a driver and a first interface. The driver may be connected to the control module, the first interface, and the battery, respectively. The first interface may be configured to connect to an external energy source, which can charge the battery through the first interface.

The second charge module may include a voltage boost driver and a second interface. The voltage boost driver may be connected to the control module, the battery, and the second interface, respectively. The second interface may be configured to electrically connect to a terminal through contact pins in order to charge the terminal. The voltage boost driver may boost an output voltage of the battery to a required rated voltage of the terminal.

The remaining capacity computation module may be configured to adjust the remaining capacity value of the battery in real time according to a discharging curve of the battery.

The communication module may be configured to connect to the terminal through the contact pins and send the adjusted remaining capacity value outputted from the remaining capacity computation module to the terminal, which may thus display the remaining capacity value of the battery.

The second interface may be a USB interface including 5 metal contact pins.

The remaining capacity computation module may be configured to collect an instantaneous discharge current of the battery, search, in the battery discharging curve stored in the wearable power supply, for the corresponding remaining capacity value of the discharge current, and adjust the remaining capacity value of the battery based on the searched remaining capacity value.

The wearable power supply may further include multiple LED (light-emitting diode) power indication lights connected to the control module. The LED power indication lights may be lit up when the battery is charging the terminal or the external energy source is charging the battery.

The wearable power supply may further include a button selector switch connected to the control module. The button selector switch may be used to control the charge and discharge of the battery.

The wearable power supply may further include a magnet, and may be fixed onto the terminal by the attraction of the magnet and an enclosure of the terminal.

The wearable power supply may be of a cylindrical shape, and a height of the wearable power supply may be smaller than 1 mm.

The first interface may be a micro universal serial bus (Micro USB).

The terminal may be a smart watch.

To achieve the above objectives, another technical solution adopted by the disclosure is to provide a power supply method of a wearable power supply. The power supply method may include:

boosting an output voltage of a battery of the wearable power supply to a required rated voltage of a terminal electrically connected to the wearable power supply, and charging the terminal via an interface connecting the wearable power supply and the terminal;

adjusting the remaining capacity value of the battery in real time based on a battery discharging curve when the battery is charging the terminal;

sending the adjusted remaining capacity value to the terminal, and displaying by the terminal the adjusted remaining capacity value of the battery.

Advantages of the disclosure may follow: distinguished from the prior art, the disclosure provides a wearable power supply including a first charge module used to charge the wearable power supply, and a second charge module used to charge a terminal electrically connected to the wearable power supply, thus the second charge module may electrically connect to the terminal via contact pins, through which the terminal can be charged directly without the need of a data cable, thus reducing the overall size of the wearable power supply, and also adding to the convenience and simplicity of usage of the wearable power supply. In addition, the wearable power supply may further include a remaining capacity computation module configured to adjust the remaining capacity value of the battery based on the battery discharging curve, and a communication module configured to transmit the remaining capacity value of the battery to the terminal, thus the terminal can display the accurate and realtime remaining capacity value of the wearable power supply for the user's reference, which adds to the user experience and further improves the precision of the remaining battery capacity value displayed.

### BRIEF DESCRIPTION OF THE DRAWINGS

FIG. 1 is a perspective view of a wearable power supply according to an embodiment of the disclosure.

FIG. 2 is a block diagram of a wearable power supply according to an embodiment of the disclosure.

FIG. 3 is a block diagram of a wearable power supply according to another embodiment of the disclosure.

FIG. 4 is a block diagram of a wearable power supply according to yet another embodiment of the disclosure.

FIG. 5 is a flow chart illustrating a power supply method of a wearable power supply according to an embodiment of the disclosure.

### DETAILED DESCRIPTION OF THE DISCLOSURE

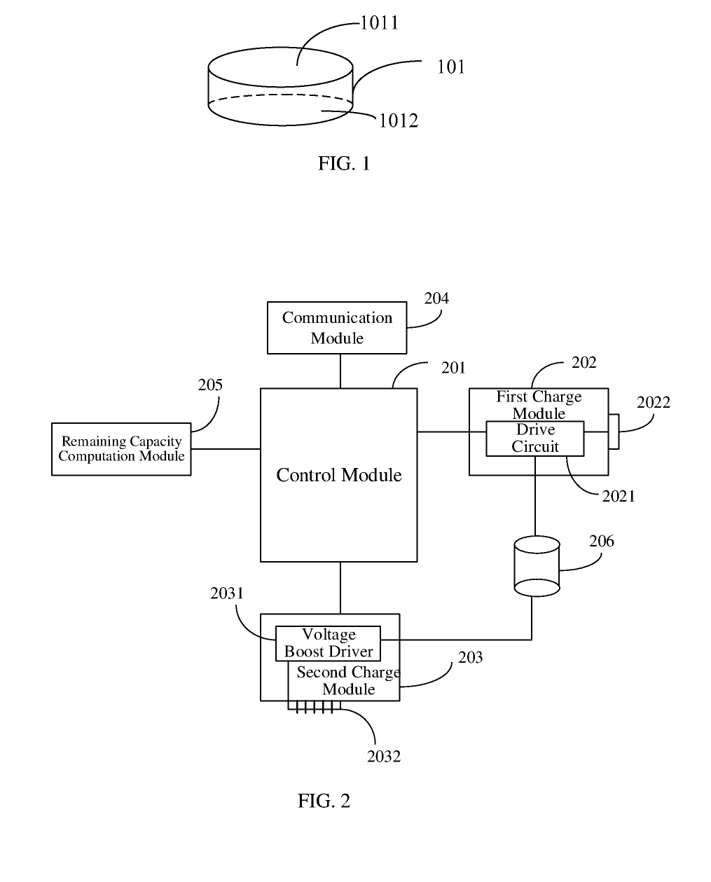

Referring to FIG. 1, there is shown a perspective view of a wearable power supply according to an embodiment of the disclosure.

The wearable power supply 101 may be of a cylindrical shape and may include a top surface 1011 and a bottom surface 1012, and, for portability, a thickness (or height measured from the top surface 1011 to the bottom surface 1012) of the wearable power supply 101 may be smaller than 1 mm. An enclosure of the wearable power supply 101 may be of a heat-resistant and heat conductive metal.

In other embodiments, a cross section of the wearable power supply 101 can also be of other shapes, such as a square, etc.

The wearable power supply 101 may include a magnet, and may be fixed onto the terminal, which is to be charged, by the attraction between the magnet and the metal enclosure of the terminal. The terminal may include a smart watch, a mobile phone, or any other mobile devices. In other embodiments, the wearable power supply 101 may be fixed onto the terminal by other manners.

Referring now to FIG. 2, there is shown a block diagram of a wearable power supply according to an embodiment of the disclosure. The wearable power supply includes a control module 201, a battery 206; and a first charge module 202 and a second charge module 203, which are connected to the control module 201.

The first charge module 202 may be located at a side wall of the wearable power supply, and used to charge the wearable power supply using an external energy source. The second charge module 203 may be used to charge a terminal that is connected to the wearable power supply.

To avoid over-charge or over-discharge of the battery 206, the battery 206 of this embodiment is implemented as a battery containing lithium polymer cells. In addition, the battery 206 can also be other batteries enabled with over-charge or over-discharge protection.

The first charge module 202 may include a driver 2021 and a first interface 2022. The driver 2021 may be connected to the control module 201. The driver 2021 may further be connected to the first interface 2022 and the batter 206, respectively. The first charge module 202 may drive the first interface 2022 via the driver 2021, thus the battery 106 can be charged by an external energy source connected to the first interface 2022.

Optionally, to further reduce the size of the wearable power supply, the first interface 2022 can be implemented as a micro universal serial bus (USB). In some embodiments, however, the first interface 2022 can also be implemented as other interfaces, such as a mini USB interface.

The second charge module 203 may include a voltage boost driver 2031 and a second interface 2032. The voltage boost driver 2031 may be connected to the control module 201, and may further be connected to the second interface 2032 and the battery 206, respectively. The voltage boost driver 2031 may step up a voltage outputted from the battery 206, when the second interface 2032 is electrically connected to a terminal. The output voltage of the battery may be boosted to a required rated voltage of the terminal, so as to ensure charge safety and proper charge voltage of the terminal. For example, suppose the rated voltage of the terminal electrically connected to the wearable power supply is 5 volts (V), then the voltage boost driver 2031 may elevate the output voltage from the battery 206 to 5V under the control of the control module 201, and then output the voltage of 5V to the second interface 2032 and thus charge the terminal.

Optionally, the second interface 2032 may be a 5 Pin USB interface including 5 metal contact pins. Of the 5 metal contact pins, two may either be a signal line contact pin, another two may either be a data line contact pin, and the last an ID pin. The 5 Pin USB interface may not only add to the simplicity, but effectively reduce the overall size of the wearable power supply. Furthermore, the terminal can be charged directly eliminating the need of a data cable, which thus adds to the convenience and portability and also saves the used space and cost.

According to a specific embodiment, when the wearable power supply is in a charged state and the first interface 2022 is in an electrical connection with an external energy source, the driver 2021 may drive the first charge module 202 under the control of the control module 201, to charge the battery 206 through the first interface 2022. When the charging of the battery 206 is completed, the first interface 2022 will be disconnected from the external energy source.

When the wearable power supply is charging a terminal, such as a smart watch, the wearable power supply may be attached onto the terminal via the attraction of a magnet built in the wearable power supply and the enclosure of the terminal. Thus, the wearable power supply can be fixed onto the back of the smart watch, which thus form a whole. Typically, the area of the cross section of the wearable power supply is not greater than the area of the dial of the smart watch. If the control module 201 of the wearable power supply detects that the 5 metal contact pins are each in an electrical connection with a corresponding contact of the smart watch, the wearable power supply will boost the voltage outputted from the battery 206 to the required rated voltage of the smart watch, for example, 5V, and thus automatically charge the smart watch via the second interface 2032.

Furthermore, to facilitate the user to know the current remaining capacity of the wearable power supply, a communication module 204 may further be included, as shown in FIG. 2. The communication module 204 may be configured to connect to the terminal via electrical contact connections to send the current remaining capacity value of the wearable power supply to the terminal, which may thus display the remaining capacity value of the wearable power supply.

For example, when the 5 metal contact pins of the wearable power supply are each in an electrical connection with a corresponding contact pin of a smart watch, and the communication module 204 are also electrically connected to the communication contact pins of the smart watch, then the communication module 204 will send a percentage representing the remaining capacity of the battery 206 of the wearable power supply to the smart watch in real time, thus the user can acquire the remaining battery capacity of the wearable power supply by the percentage displayed on the dial of the smart watch.

According to another embodiment, when the remaining capacity of the battery 206 of the wearable power supply is lower than a predetermined value, the terminal that is electrically connected to the wearable power supply can issue an alert, to notify the user of the current low battery status of the wearable power supply.

Though the communication module 204 can send the real time percentage representing the remaining capacity of the battery to the terminal, such as a smart watch, deviations would inevitably occur during the discharge process of the battery 206 due to circuit design or manufacture, resulting in an inaccurate detection precision. In addition, when the wearable power supply itself detects the remaining capacity, the detection precision would also be affected.

To address the above issue, the wearable power supply of this embodiment may further include a remaining capacity computation module 205, as shown in FIG. 2. The remaining capacity computation module 205 may adjust the remaining capacity value of the battery in real time according to a battery discharging curve.

Specifically, the remaining capacity computation module 205 may first control the initialization of a coulometer to measure the instantaneous discharge current, which is then passed through an analog-to-digital converter (ADC) to be converted to a corresponding voltage, which is then searched in the battery discharging curve for a corresponding energy consumption value. The energy consumption value acquired at each measurement-conversion-search process will be cumulated to determine the total energy consumption in the battery up to the current moment, and the percentage indicating the remaining battery capacity would be adjusted synchronously in accordance with the total energy consumption calculated.

In the current embodiment, the detection period of the discharge current by the remaining capacity computation module 205 is 1 minute. To further enhance the displayed precision to enable the displayed remaining capacity to change more smoothly, the detection period can also be shortened, for example, the discharge current can be detected every half a minute. However, the detection action will also consume the battery's energy, thus, for consideration of saving the battery's power, the detection period shouldn't be infinitely shortened.

The communication module 204 may then send the adjusted remaining capacity value to the terminal, such as a smart watch, which may display the adjusted remaining capacity value on its display, such as a dial of the smart watch.

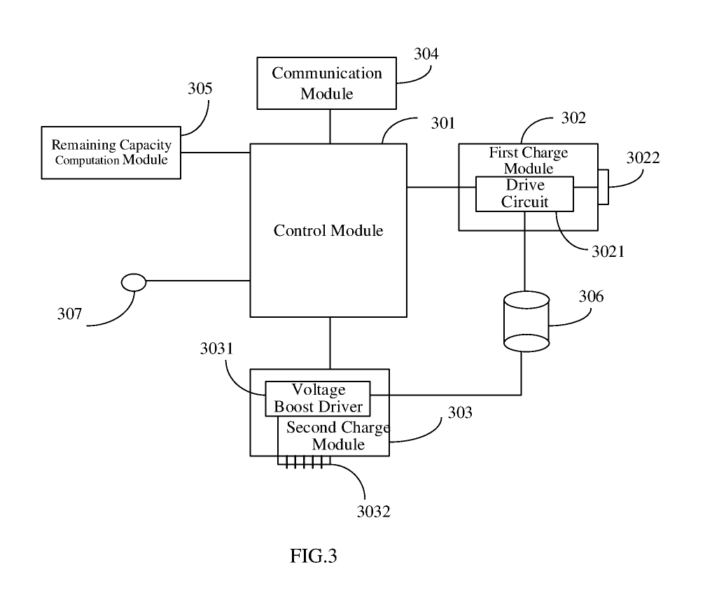

To notify the user of the current charge or discharge state of the wearable power supply, referring now to FIG. 3, there is shown a block diagram of a wearable power supply according to another embodiment of the disclosure. The wearable power supply is different from the above embodiment in that, it further includes multiple LED (light-emitting diode) power indication lights 307. The LED power indication lights 307 may be connected to the control module 301, and may be lit up when the battery 306 is charging a terminal electrically connected to the wearable power supply or when an external energy source is charging the battery 306. The LED power indication lights 307 can thus notify the user of the current charge or discharge state of the wearable power supply.

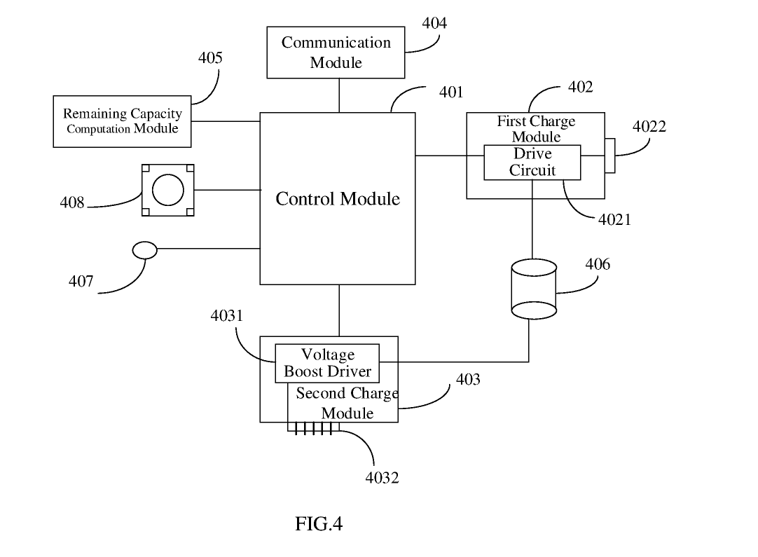

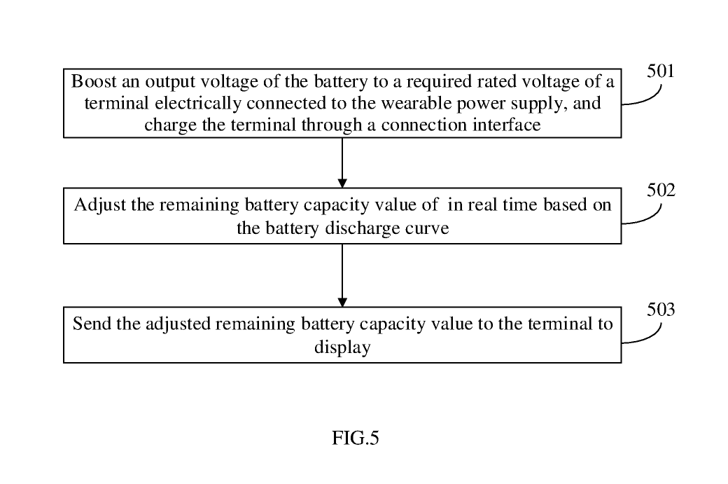

To render more flexible charge and/or discharge control over the wearable power supply, referring now to FIG. 4, there is shown a block diagram of a wearable power supply according to yet another embodiment of the disclosure. The wearable power supply differs from the above embodiment in that, it further includes a button selector switch 408, which is connected to the control module 401 and configured to control the charge and discharge of the battery.

Distinguished from the prior art, the wearable power supply according to this embodiment includes a first charge module used to charge the wearable power supply, and a second charge module used to charge a terminal electrically connected to the wearable power supply, where the second charge module may electrically connect to the terminal via contact pins, through which the terminal can be charged directly without the need of a data cable, thus reducing the overall size of the wearable power supply and adding to the convenience and simplicity of usage of the wearable power supply. In addition, the wearable power supply may further include a remaining capacity computation module configured to adjust the remaining battery capacity value based on the battery discharging curve, and a communication module configured to send the remaining battery capacity value to the terminal to display. Thus, the terminal can display the realtime and accurate remaining capacity of the wearable power supply for the user's reference.

Referring now to FIG. 5, there is show a flow chart illustrating a power supply method of a wearable power supply. The power supply method may include the following steps.

In a first step 501, an output voltage of a battery of the wearable power supply is boosted to a required rated voltage of a terminal electrically connected to the wearable power supply, thus the terminal can be charged via a connection interface connecting the wearable power supply and the terminal.

To ensure the charge safety and a proper power supply to the terminal, when the wearable power supply is charging the terminal, the output voltage of the wearable power supply would be stepped up to the required rated voltage of the terminal, which thus can be charged through the connection interface.

For example, suppose the rated voltage of the terminal electrically connected to the wearable power supply is 5 volts (V), then the voltage boost driver 2031 may elevate the output voltage from the battery 206 to 5V under the control of the control module 201, and then output the voltage of 5V to the second interface 2032 and thus charge the terminal.

To facilitate the user to know the current remaining capacity of the wearable power supply, the wearable power supply can send its current remaining capacity value to the terminal to display the remaining capacity value on a display of the terminal.

For example, when the wearable power supply is connected to a smart watch via an interface, the wearable power supply can send a percentage representing the remaining capacity of the battery of the wearable power supply to the smart watch in real time, thus the user can know the remaining battery capacity of the wearable power supply from the percentage displayed on the dial of the smart watch.

According to another embodiment, to notify the user of the current charge or discharge state of the wearable power supply, the method may further include a step that the wearable power supply lights up at least one LED power indication light for notification. In other embodiments, the LED power indication lights can be lit up when the wearable power supply is in the charged state.

In another embodiment, the method may further include a step of turning on a button selector switch, before the wearable power supply builds up an electrical connection with a terminal to be charged. Thus a more flexible charge and/or discharge control of the wearable power supply can be achieved. The method may continue to step 502.

In the next step 502, when the wearable power supply is charging the terminal, the remaining battery power value is adjusted in real time based on a battery discharging curve.

Though the wearable power supply can send the real time percentage representing the remaining capacity of the battery to the terminal, such as a smart watch, deviations would inevitably occur during the discharge process of the battery due to circuit design or manufacture, resulting in an inaccurate detection precision. In addition, when the wearable power supply itself detects its remaining capacity, the detection precision would also be affected.

To address the above issue, according to the power supply method of the current embodiment, the remaining battery capacity will be adjusted in real time based on the battery discharging curve.

Specifically, the wearable power supply may first control the initialization of a coulometer to measure the current discharge current, which is then passed through an analog-to-digital converter (ADC) to be converted to the corresponding voltage, which is then searched in the battery discharging curve for a corresponding energy consumption value. The energy consumption value acquired at each measurement-conversion-search period will be cumulated to determine the total energy consumption in the battery up to the current moment, and the percentage indicating the remaining battery capacity value would be adjusted synchronously in accordance with the total energy consumption calculated.

In the current embodiment, the detection period of the discharge current by the wearable power supply is 1 minute. To further enhance the displayed precision to enable the displayed remaining capacity value to change more smoothly, the detection period can also be shortened, for example, the discharge current can be detected every half a minute. However, the detection action will also consume the battery's energy, thus, for consideration of saving the battery's power, the detection period shouldn't be infinitely shortened. The method may proceed to step S503.

In the following step S503, the adjusted remaining battery capacity value is sent to the terminal, which thus displays the remaining batter capacity value.

According to another embodiment, when the remaining capacity of the battery of the wearable power supply is lower than a predetermined value, the terminal that is electrically connected to the wearable power supply can issue an alert, to notify the user of the current low battery status of the wearable power supply.

Distinguished from the prior art, in the power supply method of the wearable power supply according to this embodiment, the wearable power supply can boost the output voltage of the battery to the required rated voltage of the terminal electrically connected to the wearable power supply, thus the terminal can be charged via the connection interface connecting the wearable power supply and the terminal, eliminating the need of data cables. Furthermore, the overall size and cost of the wearable power supply can be further reduced, adding to the convenience of usage. In addition, the remaining battery capacity value can be adjusted in real time based on the battery discharging curve, and the adjusted remaining battery capacity value can be sent to be displayed on the terminal. Thus, the terminal can display the realtime and accurate remaining capacity of the wearable power supply for the user's reference.

The above description is merely embodiments of the disclosure, but is not limiting the scope of the disclosure. Any equivalent structures or flow transformations made to the disclosure, or any direct or indirect applications of the disclosure on other related fields, shall all be covered within the protection of the disclosure.

1. A wearable power supply, comprising a control module, and a battery, a first charge module, a second charge module, a communication module, and a remaining capacity computation module, which are coupled to the control module, wherein
the first charge module comprises a driver and a first interface, wherein the driver is connected to the control module, the first interface, and the battery, respectively, and the first interface is configured to connect to an external energy source which charges the battery through the first interface;
the second charge module comprises a voltage boost driver and a second interface, wherein the voltage boost driver is connected to the control module, the battery, and the second interface, respectively, the second interface is a USB (universal serial bus) interface comprising a plurality of metal contact pins and is configured to electrically connect to a terminal through contact pins to charge the terminal, and the voltage boost driver is configured to step up an output voltage of the battery to a required rated voltage of the terminal;
the remaining capacity computation module is configured to adjust a remaining capacity value of the battery in real time based on a discharging curve of the battery;
the communication module is configured to connect to the terminal through the contact pins and to send the adjusted remaining capacity value from the remaining capacity computation module to the terminal to display; and
the wearable power supply further comprises a plurality of LED (light-emitting diode) power indication lights connected to the control module, the LED power indication lights being configured to light up when the battery is charging the terminal or when the external energy source is charging the battery.

2. The wearable power supply according to claim 1, wherein the remaining capacity computation module is configured to collect an instantaneous discharge current of the battery, search, in the battery discharging curve stored in the wearable power supply, for a corresponding remaining capacity value of the instantaneous discharge current, and adjust the remaining capacity value of the battery in real time based on the searched remaining capacity value.

3. The wearable power supply according to claim 1, wherein the wearable power supply further comprises a magnet, and is stacked and secured onto the terminal via the attraction of the magnet and an enclosure of the terminal.

4. (canceled)

5. The wearable power supply according to claim 1, wherein the first interface is a micro universal serial bus (Micro USB).

6. The wearable power supply according to claim 1, wherein the terminal is a smart watch.

7. A wearable power supply, comprising a control module, and a battery, a first charge module, a second charge module, a communication module, and a remaining capacity computation module, which are connected to the control module, wherein
the first charge module comprises a driver and a first interface, wherein the driver is connected to the control module, the first interface, and the battery, respectively, and the first interface is configured to connect to an external energy source which charges the battery through the first interface;
the second charge module comprises a voltage boost driver and a second interface, wherein the voltage boost driver is connected to the control module, the battery, and the second interface, respectively, the second interface is configured to electrically connect to a terminal through contact pins to charge the terminal, and the voltage boost driver is configured to step up an output voltage of the battery to a required rated voltage of the terminal;
the remaining capacity computation module is configured to adjust a remaining capacity value of the battery in real time based on a discharging curve of the battery; and
the communication module is configured to connect to the terminal through the contact pins and to send the adjusted remaining capacity value from the remaining capacity computation module to the terminal to display.

8. The wearable power supply according to claim 7, wherein the second interface is a USB (universal serial bus) interface comprising 5 metal contact pins.

9. The wearable power supply according to claim 7, wherein the remaining capacity computation module is configured to collect an instantaneous discharge current of the battery, search, in the battery discharging curve stored in the wearable power supply, for a corresponding remaining capacity value of the instantaneous discharge current, and adjust the remaining capacity value of the battery in real time based on the searched remaining capacity value.

10. The wearable power supply according to claim 7, further comprising a plurality of LED (light-emitting diode) power indication lights connected to the control module, the LED power indication lights being configured to light up when the battery is charging the terminal or when the external energy source is charging the battery.

11. The wearable power supply according to claim 7, further comprising a button selector switch connected to the control module and configured to control charge and discharge of the battery.

12. The wearable power supply according to claim 7, wherein the wearable power supply further comprises a magnet, and is stacked and secured onto the terminal via the attraction of the magnet and an enclosure of the terminal.

13. (canceled)

14. The wearable power supply according to claim 7, wherein the first interface is a micro universal serial bus (Micro USB).

15. The wearable power supply according to claim 7, wherein the terminal is a smart watch.

16. A power supply method of a wearable power supply, comprising:
boosting an output voltage of a battery of the wearable power supply to a required rated voltage of a terminal electrically connected to the wearable power supply, and charging the terminal via an interface connecting the wearable power supply and the terminal;
adjusting a remaining capacity value of the battery in real time based on a discharging curve of the battery when the battery is charging the terminal; and
sending the adjusted remaining capacity value to the terminal, to display the remaining capacity value of the battery on the terminal.

17. The wearable power supply according to claim 7, further comprising an enclosure of a heat-resistant and conductive material.

18. The wearable power supply according to claim 7, wherein the battery comprises a plurality of lithium polymer cells.

19. The power supply method according to claim 16, wherein the block of adjusting the remaining capacity value of the battery in real time comprises:
initiating a coulometer to measure an instantaneous discharge current of the battery;
searching the instantaneous current in a discharge curve of the battery, stored in the wearable power supply, for a corresponding energy consumption value; and
cumulating the energy consumption value acquired at each time to determine a total energy consumption value up to current moment, and calculating the remaining capacity value of the battery.

20. The power supply method according to claim 19, wherein the block of searching the instantaneous current in the discharge curve of the battery for the corresponding energy consumption value comprises;
passing the instantaneous current through an analog-to-digital converter (ADC) to output a corresponding voltage; and
searching the voltage in the battery discharge curve for the corresponding energy consumption value.

21. The power supply method according to claim 19, wherein a detection period of the discharge current by the wearable power supply is 1 minute.

22. The power supply method according to claim 16, further comprising:
when the remaining capacity value of the battery is lower than a predetermined value, issuing, by the terminal, an alert to notify the user of the current lower battery status of the wearable power supply.
